(19) United States
(12) Patent Application Publication
(10) Pub. No.: US 2013/0138506 A1
(43) Pub. Date: May 30, 2013

(54) ESTIMATING USER DEMOGRAPHICS

(71) Applicant: Google Inc., Mountain View, CA (US)

(72) Inventors: Bogong Zhu, Shanghai (CN); QIN Zhuang, Shanghai (CN); Cheng Xu, Shanghai (CN); Ching Law, Shatin N.T. (HK)

(73) Assignee: Google Inc., Mountain View, CA (US)

(21) Appl. No.: 13/652,198

(22) Filed: Oct. 15, 2012

Related U.S. Application Data
(63) Continuation of application No. PCT/CN2011/083277, filed on Nov. 30, 2011.

(51) Int. Cl. G06Q 30/02

(52) U.S. Cl. 705/14.53; 705/14.66

(57) ABSTRACT

Systems and methods for estimating user demographics may be used to target online advertisements to users of a certain demographic. Known demographics for a set of users are used to train a model by associating characteristics of webpages visited by the users with the known demographics. The model is used to estimate the demographic of another user by matching one or more characteristics of a requested webpage to those in the model. An online advertisement may be selected based in part on the estimated demographic of the user.

This application claims priority to PCT Application No. PCT/CN2011/083227, entitled “Estimating User Demographics,” and filed on Nov. 30, 2011, the entirety of which is hereby incorporated by reference.

### BACKGROUND

The amount of available information regarding the demographics of visitors to a webpage is often limited. Information about the client device itself (e.g., the device's IP address, browser type, system information, etc.) may be available via cookie data. For example, a website may be able to determine that a personal computer requesting the webpage is running a particular web browser and/or operating system. Information about the actual user of the client device, however, may still require the user to self-identify demographic information. In particular, unless specified by the user, information indicating whether the user of the computer is male or female, old or young, etc., may be unavailable to the webpage.

### SUMMARY

Implementations of the systems and methods for estimating user demographics are described herein. One implementation is a computerized method for estimating a demographic of a user. The method includes receiving, at a processing circuit, a request for an advertisement to be placed on a webpage requested by a user, the webpage having text. The method also includes determining, by a processing circuit, one or more webpage word clusters, each webpage word cluster including a word in the text of the webpage. The method further includes matching the one or more webpage word clusters to one or more word clusters in a demographics model. Each word cluster in the demographics model is associated with a probability of a user belonging to a demographic. The method also includes estimating a demographic of the user based in part on the one or more probabilities associated with the word clusters in the demographics model that match the one or more webpage word clusters. The method additionally includes providing the advertisement based in part on the estimated demographic of the user.

Another implementation is a system for estimating a demographic of a user. The system includes a processing circuit operative to receive a request for an advertisement to be placed on a webpage requested by a user, the webpage having text. The processing circuit is also operative to determine one or more webpage word clusters, each webpage word cluster including a word in the text of the webpage. The processing circuit is further operative to match the one or more webpage word clusters to one or more demographics model word clusters. Each demographics model word cluster is associated with a demographics probability. The processing circuit is also operative to estimate a demographic of the user based in part on the one or more demographics probabilities associated with the demographics model word clusters that match the one or more webpage word clusters. The processing circuit is further operative to provide the advertisement based in part on the estimated demographic of the user.

A further implementation is a computer-readable medium having machine instructions stored therein, the instructions being executable by one or more processors to cause the one or more processors to perform operations. The operations include receiving a request for an advertisement to be placed on a webpage requested by a user, the webpage having text. The operations also include determining one or more webpage word clusters, a webpage word cluster including a word in the text of the webpage. The operations further include matching the one or more webpage word clusters to one or more word clusters in a demographics model. A word cluster in the demographics model has an associated probability of the user belonging to a demographic. The operations also include estimating a demographic of the user based in part on the one or more probabilities associated with the word clusters in the demographics model that match the one or more webpage word clusters. The operations additionally include providing the advertisement based in part on the estimated demographic of the user.

Another implementation is a computerized method for estimating user demographic data. The method includes receiving, at a processing circuit, demographic data for a set of users. The method also includes retrieving, from a memory, browser history data for the set of users. The method further includes associating, by the processing circuit, the demographic data with one or more characteristics of webpages in the browser history data. The method also includes receiving a request for an advertisement to be placed on a webpage requested by a user. The method yet further includes identifying characteristics of the webpage that match the characteristics of webpages in the browser history data. The method also includes retrieving demographic data associated with the identified characteristics of webpages. The method further includes providing the advertisement based in part on the retrieved demographic data.

A further implementation is a system for estimating user demographics. The system includes a processing circuit operative to receive demographic data for a set of users. The processing circuit is also operative to receive browser history data for the set of users. The processing circuit is further operative to associate the demographic data with one or more characteristics of webpages in the browser history data. The processing circuit is also operative to receive a request for an advertisement to be placed on a webpage requested by a user. The processing circuit is additionally operative to estimate a demographic of the user by matching one or more characteristics of the webpage with the one or more characteristics with which demographic data is associated. The processing circuit is yet further operative to provide the advertisement based in part on the estimated demographic.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an example webpage having an advertisement;

FIG. 3 is an example process for estimating user demographics based on the content of a webpage;

FIG. 4 is an illustration of a model being trained to estimate user demographics;

FIG. 5 is an illustration of a model being trained to estimate a user's gender;

FIG. 6 is an illustration of an online advertisement being provided based on estimated user demographics;

FIG. 7 is an illustration of a user's gender being estimated based on page content.

Like reference numbers and designations in the various drawings indicate like elements.

### DETAILED DESCRIPTION

According to some aspects of the present disclosure, one or more characteristics of a webpage can be used to estimate the demographics of a visitor to the webpage. In some implementations, the content of the webpage itself is used in the estimation. For example, specific words, topics, ideas, tags, keywords, etc., on the webpage may be associated with certain demographic groups. In some implementations, user demographics for a set of known users are used to train a model. The model may associate known user demographics with one or more characteristics of a webpage. When a user having unknown demographics visits a webpage, the characteristics of the webpage can be used with the model to estimate the demographics of the user. In some implementations, other sources of demographics data may be publisher-provided (e.g., if the user includes demographics data as part of a user profile or to enter a website) or inferred from the user's browsing history (e.g., by applying a model to the historical set of webpages visited by the user).

Traditionally, demographics data about online users has been unavailable to website operators, online advertisers, and other interested parties. For example, a family may share a home computer to browse webpages. From the standpoint of an Internet server, all that is known when a webpage is requested is information about the requesting device (e.g., the home computer). Which family member (e.g., the father, mother, daughter, etc.) is operating the computer at the time is entirely inaccessible to the server, unless the user self-identifies their demographic information. For example, the user at the time may be a 50-year old male, a 48-year old female, or an 18-year old female. For this reason, advertisers wishing to target a specific demographic (e.g., females between the ages of 18-25) are unable to do so with certainty on a large number of websites.

Different approaches may be used to provide advertisements on a webpage. In some implementations, a website operator may contract with an advertising network to embed advertisements into their webpages. For example, the code for a webpage may include one or more commands to retrieve an advertisement from the advertising network when the webpage is requested by a client device. The advertising network may select which advertisement is presented from among different participating advertisers. In some cases, an advertiser in the advertising network may specify which demographics are to be targeted by their advertisement. In various implementations, the advertising network may estimate a demographic of a user requesting a webpage based on a demographics model and the content of the webpage itself (e.g., the text or other content on the webpage). The advertising network may then base the advertisement selection on the estimated demographic.

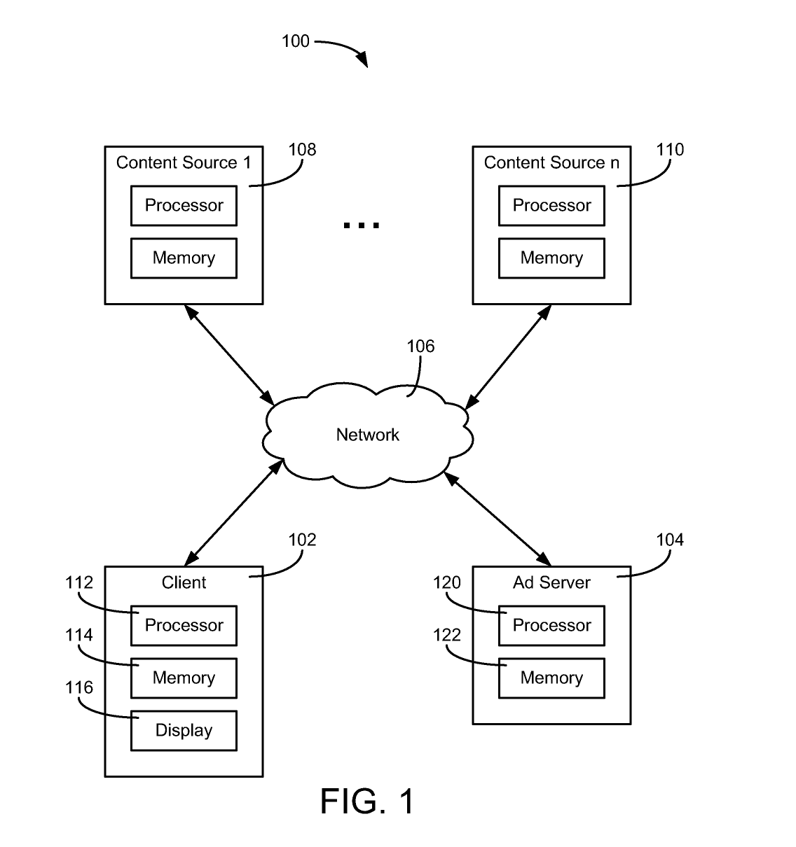

Referring to FIG. 1, a block diagram of a computer system 100 in accordance with a described implementation is shown. System 100 includes a client 102 which communicates with other computing devices via a network 106. For example, client 102 may communicate with one or more content sources ranging from a first content source 108 up to an nth content source 110. Content sources 108, 110 may provide webpages and/or media content (e.g., audio, video, and other forms of digital content) to client 102. System 100 may also include an advertisement server 104, which provides advertisement data to other computing devices over network 106.

Network 106 may be any form of computer network that relays information between client 102, advertisement server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from advertisement server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data. Similarly, advertisement server 104 may include a processing circuit including a processor 120 and a memory 122. In some implementations, advertisement server 104 may include several computing devices (e.g., a data center, a network of servers, etc.). In such a case, the various devices of advertisement server 104 may be in electronic communication, thereby also forming a processing circuit (e.g., processor 120 includes the collective processors of the devices and memory 122 includes the collective memories of the devices).

Advertisement server 104 may provide digital advertisements to client 102 via network 106. For example, content source 108 may provide a webpage to client 102, in response to receiving a request for a webpage from client 102. In some implementations, an advertisement from advertisement server 104 may be provided to client 102 indirectly. For example, content source 108 may receive advertisement data from advertisement server 104 and use the advertisement as part of the webpage data provided to client 102. In other implementations, an advertisement from advertisement server 104 may be provided to client 102 directly. For example, content source 108 may provide webpage data to client 102 that includes a command to retrieve an advertisement from advertisement server 104. On receipt of the webpage data, client 102 may retrieve an advertisement from advertisement server 104 based on the command and display the advertisement when the webpage is rendered on display 116.

According to various implementations, advertisement server 104 may provide an advertisement to client 102 based in part on an estimated demographic of the user of client 102. In some implementations, advertisement server 104 may use a model that relates webpage characteristics to user demographics. For example, the visitors of webpages provided by content source 108 may differ demographically from those of content source 110 (e.g., the majority of visitors to content source 108 may be females between the ages of 18-25, while the majority of visitors to content source 110 may be males between the ages of 50-55). As part of the advertisement selection process, advertisement server 104 may determine one or more characteristics of the requested webpage and use the model to estimate the demographics of the user.

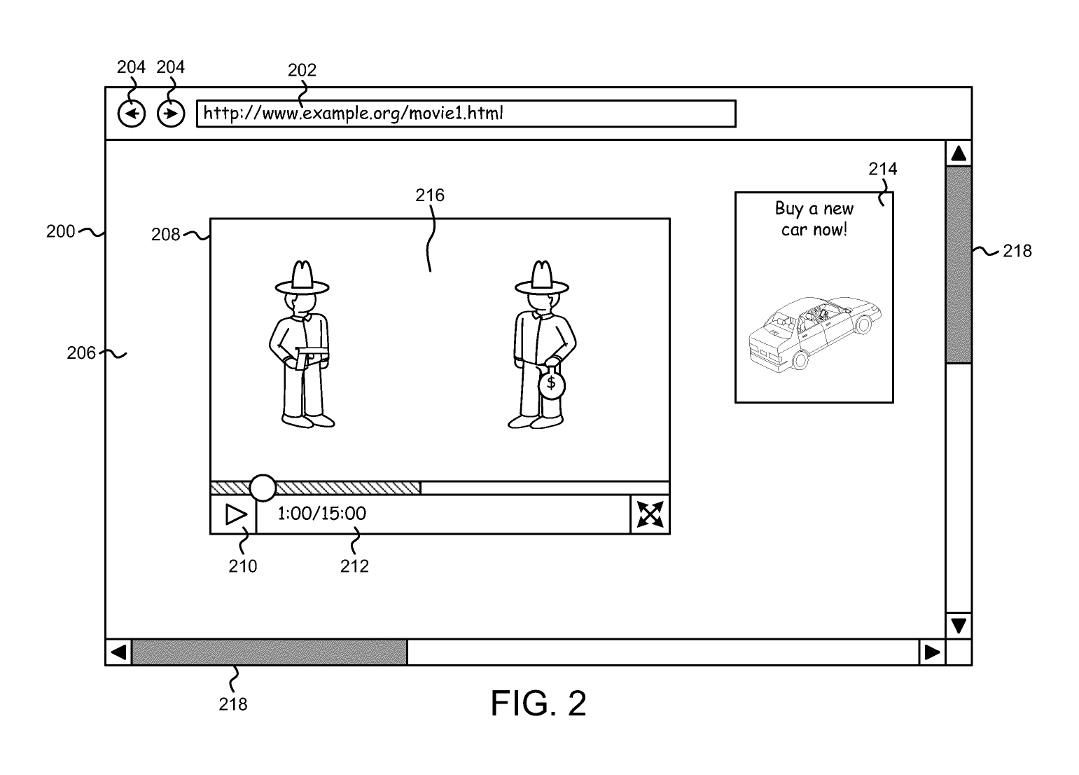

Referring now to FIG. 2, an example display 200 is shown. Display 200 is in electronic communication with one or more processors that cause visual indicia to be provided on display 200. Display 200 may be located inside or outside of the housing of the one or more processors. For example, display 200 may be external to a desktop computer (e.g., display 200 may be a monitor), may be a television set, or any other stand-alone form of electronic display. In another example, display 200 may be internal to a laptop computer, mobile device, or other computing device with an integrated display.

As shown in FIG. 2, the one or more processors in communication with display 200 may execute a web browser application (e.g., display 200 is part of a client device). The web browser application operates by receiving input of a uniform resource locator (URL) into a field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide webpage data and/or other data to the client device, which causes visual indicia to be displayed by display 200.

In general, webpage data may include text, hyperlinks, layout information, and other data that is used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “moviel.html” provided by the website, “www.example.org.” The webpage data may include data that specifies where indicia appear on webpage 206, such as movie 216 or other visual objects. In some implementations, the webpage data may also include additional URL information used by the client device to retrieve additional indicia displayed on webpage 206. For example, the file, “moviel.html,” may also include one or more advertisement tags used to retrieve advertisement 214 from a remote location (e.g., an advertisement server, the content source that provides webpage 206, etc.) and to display advertisement 214 on display 200.

The web browser providing data to display 200 may include a number of navigational controls associated with webpage 206. For example, the web browser may include the ability to go back or forward to other webpages using inputs 204 (e.g., a back button, a forward button, etc.). The web browser may also include one or more scroll bars 218, which can be used to display parts of webpage 206 that are currently off-screen. For example, webpage 206 may be formatted to be larger than the screen of display 200. In such a case, one or more scroll bars 218 may be used to change the vertical and/or horizontal position of webpage 206 on display 200.

In one example, additional data associated with webpage 206 may be configured to perform any number of functions associated with movie 216. For example, the additional data may include a media player 208, which is used to play movie 216. Media player 208 may be called in any number of different ways. In one implementation, media player 208 may be an application installed on the client device and launched when webpage 206 is rendered on display 200. In another implementation, media player 208 may be part of a plug-in for the web browser. In another implementation, media player 208 may be part of the webpage data downloaded by the client device. For example, media player 208 may be a script or other form of instruction that causes movie 216 to play on display 200. Media player 208 may also include a number of controls, such as a button 210 that allows movie 216 to be played or paused. Media player 208 may include a timer 212 that provides an indication of the current time and total running time of movie 216.

The various functions associated with advertisement 214 may be implemented by including one or more advertisement tags within the webpage code located in “moviel.html” and/or other files. For example, “moviel.html” may include an advertisement tag that specifies that an advertisement slot is to be located at the position of advertisement 214. Another advertisement tag may request an advertisement from a remote location, for example, from an advertisement server, as webpage 206 is loaded. Such a request may include one or more keywords or other data used by the advertisement server to select an advertisement to provide to the client. According to some implementations, one or more characteristics of the webpage may be provided to the advertisement server as part of the request for an advertisement. In other implementations, the advertisement server may request the webpage directly, to determine its characteristics.

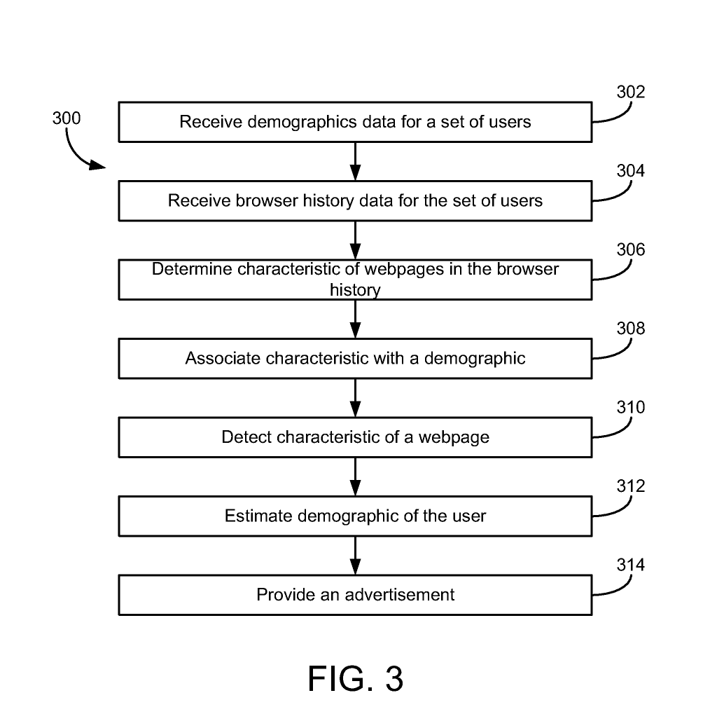

FIG. 3 is an example process 300 for estimating user demographics based on the content of a webpage. Process 300 includes receiving demographic data for a set of users (block 302). In some implementations, the demographic data may be self-reported by users. For example, a user may provide demographic information to access a website or as part of a registration process to create a user profile. In another example, a user may provide demographic information to activate an electronic device (e.g., a mobile phone, a tablet PC, etc.). According to various implementations, the demographics data may be received by a content source, an advertisement server, and/or by another computing device.

Demographics data will be understood to include any factor or set of factors by which a population of users can be divided. According to various implementations, demographics data may include a user's age, gender, race, ethnicity, employment status, education level, income, mobility, familial status (e.g., married, single and never married, single and divorced, etc.), household size, hobbies, interests, location, religion, political leanings, or any other characteristic describing a user or a user's beliefs or interests. In some cases, demographics data can include information that may be quantified, for example to provide high levels of granularity (e.g., several options in a particular category, rather than a simple binary factor). A collection of demographic data values can be selected to define a particular demographic segment identifying a subset of users. In some implementations, demographics data may be a combination of factors. For example, a particular demographic segment may be males between the ages of 45-50 that are married and have an income over $65,000 per year. In one implementation, some of the demographics data may be self-reported (e.g., by the particular user), while other demographics data may be inferred from information provided by the user or another user. For example, a user may specify their employer and job title on a social networking website. If the employer publishes salary information, the user's income may be determined by cross-referencing the self-identified information provided by the user with the salary information from the employer. In some cases, some of a user's demographics data may be specified by another user. For example, a user may have a profile on a social networking website. The user's friends, relatives, or acquaintances may also identify demographic information about the user (e.g., that a second user is the user's sister, that a second user attended college with the user, etc.). In these and other cases, demographics data about the user can be used in addition to, or in lieu of, self-reported demographics data. According to various implementations, a user may opt-out of their demographics data being used and/or may configure various permissions relating to their personal data. For example, a user may allow the use of only a portion of their demographics data (e.g., age and gender, but not salary). In some implementations, the demographics data may be anonymized (e.g., the demographics data is not attributed to an individual user).

Process 300 includes receiving browser history data for the set of users (block 304). Browser history data for a user may indicate one or more webpages that the user has visited. In some implementations, browser history data may be for a specified period of time. For example, the browser history data may indicate those webpages visited by a user within the past half hour, day, week, month, year, etc. Browser history data may also include information about a user's actions regarding a particular webpage. For example, browser history data may indicate whether a user navigates to another webpage via selection of a hyperlink, by directly entering a web address, by selecting an advertisement, or the like. In some cases, the browser history data may include timestamp information, such as how long a user spent browsing a particular webpage.

Browser history data may be collected in any number of different ways. In some implementations, one or more cookies may be used to collect the browser history. For example, an advertisement server may place a cookie on a client device when an advertisement is provided as part of a first webpage. When the user visits a second webpage also having an advertisement, the client device may send the cookie back to the advertisement server as part of a request for the advertisement. The cookie data can then be aggregated by the advertisement server for a particular user to reconstruct the user's browser history. In this way, the advertisement server is able to track the user's browsing history as they navigate from webpage to webpage.

In some implementations, a user's browser history may be provided by the browser itself or by another application running on the client device. For example, a user may opt in to allowing their browsing history to be tracked, in exchange for the use of certain software or the device, itself. In such a case, the user's browsing history available to the advertisement server may also include information about webpages outside of the advertising network (e.g., all webpages that a user visits).

Process 300 includes determining a characteristic of a webpage in the browser history (block 306). In general, a characteristic of a webpage may be any parameter to categorize a webpage. According to various implementations, a webpage characteristic may include the domain name of the website, a publisher-specified category, and/or the content of the webpage. For example, webpages on the same website (e.g., http://www.example.org/example1.html, http://www.example.org/example2.html, etc.) may have the characteristic of sharing the same domain name (e.g., www.example.org). In another example, a publisher may specify one or more categories for their webpage (e.g., by providing a topic category as part of an advertisement tag, etc.). Such categories can be used by an advertisement server to select an advertisement that matches the specified category. In a further example, the content of the webpage itself (e.g., based on the text, images, etc. located on the webpage may be used by the advertisement server to select an advertisement to be displayed with the webpage.

According to various implementations, the content of a webpage may be determined using word clusters. In general, a word cluster may be a set of words that convey the same or similar ideas. A word cluster may be a set of synonyms, according to one implementation. For example, the text of a webpage may include the word “hotel.” A word cluster that includes the word “hotel” may be as follows:

cluster_{—}1={inn,hotel,hostel,lodge,motel,public house,spa}

Such a cluster may be used to identify webpages devoted to the same topic, but use different terminology to do so. In some cases, a word cluster may include words that have related, but different meanings. In some implementations, a characteristic of a webpage may be a set of different word clusters. For example, the word “Seattle” may be part of a second word cluster that includes related terms:

cluster_{—}2={Seattle,Emerald City,Seatown,Rain City,Gateway to the Pacific}

A set of word clusters representing a webpage may be as follows:

{cluster_{—}1,cluster_{—}2}

Such a cluster may be used to classify the webpage as being related to hotels in Seattle.

Webpages in the browser histories for the set of users can be analyzed to determine their characteristics. In some implementations, the characteristic information may be sent to an advertisement server as part of the advertising process. For example, publisher-specified categories for a webpage and/or the domain name of the website may be sent to an advertisement server when an advertisement is requested. In some implementations, a characteristic may be determined by retrieving the webpage (e.g., text or other objects on the webpage). For example, a webpage may be retrieved to index the webpage in a search engine. Word clusters may be extracted from the webpage as part of the indexing process. In another example, an advertisement server may retrieve a webpage in the browser history to determine the characteristics of the webpage.

Process 300 includes associating a characteristic of a webpage with a demographic. According to various implementations, the demographics data for the set of users, in combination with their browser histories, can be used to train a model for estimating user demographics. For example, a set of word clusters (e.g., cluster_1, cluster_2, etc.) may categorize a particular webpage. If 85% of the webpage visitors in the set of users are male, the set of word clusters may be associated with the male demographic. Such a characteristic may be used to estimate user demographics for other webpages. For example, if another webpage has similar characteristics as that of one used to train the model, the user demographics for the webpage may be estimated as being similar to the webpage used to train the model.

Any form of machine learning may be used to model the user demographics of the webpage characteristics. According to various implementations, a logistic regression, linear regression, naïve Bayesian, or other approach may be used to model user demographics as they relate to webpage characteristics. In some implementations, an artificial neural network can be trained using the demographics data and the webpage characteristics. For example, the probability that a webpage characteristic corresponds to a particular demographic can be determined. In some cases, different webpage characteristics can be combined in the model to determine an overall probability of a user belonging to a demographic. For example, a word cluster related to baseball may have an associated probability of 0.55 that a reader of a word in the cluster is male. Another word cluster related to boxing may have an associated probability of 0.85 that a reader of a word in the cluster is male. If a webpage includes word clusters devoted to both baseball and boxing, an overall probability may be determined about the gender of the reader (e.g., by using the highest probability among different clusters, by taking the average or weighted average of the probabilities, etc.).

Process 300 includes detecting a characteristic of a webpage (block 310). In some implementations, one or more characteristics of a webpage may be determined by an advertisement server when a webpage is requested. For example, the webpage may include an advertisement slot and an advertisement tag configured to retrieve an advertisement from the advertisement server. As part of the ad serving process, the advertisement server may determine the one or more characteristics of the webpage, to determine which advertisement should be returned. In some implementations, the characteristics of the webpage may be predetermined by the advertisement server. For example, the advertisement server may retrieve and analyze the webpage when the webpage is added to the advertising network. In other implementations, the advertisement server may retrieve the one or more characteristics of the webpage, in response to receiving the request for an advertisement.

Process 300 includes estimating the demographic of the user (block 312). According to various implementations, a user having unknown demographics may request a webpage that is outside of the set of webpages used to train the model. The model may be used to estimate the user's demographics based solely on the characteristics (e.g., the content, domain, etc.) of the requested webpage. For example, the model may be trained to associate a word cluster related to baseball with a probability of 0.65 that a user is male. If a user having unknown demographics requests a new webpage devoted to baseball (e.g., one that is outside of the browser history data for the set of users), this probability may be used to estimate the demographic of the user. In some implementations, the known demographics for webpages used to train the model may be used directly to estimate the demographics regarding visitors to those webpages. In further implementations, the estimation of a user's demographic may be based on whether the user's demographic is already known. For example, self-provided and other forms of known demographic information about a specific user may be utilized instead of estimating the user's demographic via the model. In further implementations, a hybrid approach may be taken in which some of a user's demographic information is already known and other portions of the user's demographic information is estimated by the model.

Process 300 includes providing an advertisement based in part on the estimated user demographic (block 314). In some implementations, the advertisement may be provided based solely on the estimated demographic of the user. For example, an advertiser may specify that their advertisements are to be disseminated to females between the ages of 18-25. In other implementations, other factors may be used in addition to the estimated demographic. For example, an advertiser may specify that that their advertisements are to be disseminated to females between the ages of 18-25 that are browsing a webpage devoted to cruise lines in the Caribbean.

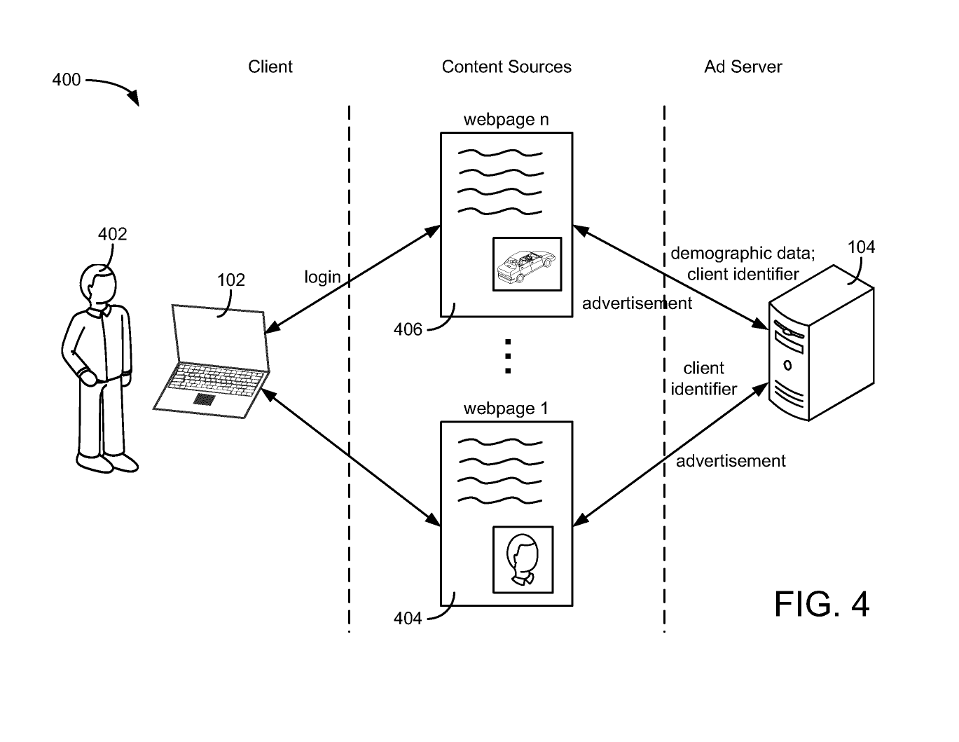

FIG. 4 is an illustration 400 of a model being trained to estimate user demographics. As shown, a user 402 may use client 102 to browse a plurality of webpages ranging from a first webpage 404 to an nth webpage 406 (e.g., by accessing content servers 108, 110 shown in FIG. 1). For example, user 402 may use client 102 to request and retrieve webpage 404. Webpage 404 may include an advertisement tag configured to cause client 102 to also retrieve an advertisement from advertisement server 104 to be included on webpage 404. In another implementation, the content server providing webpage 404 may request the advertisement from advertisement server 104 and provide the advertisement with the webpage data to client 102.

In some implementations, a client identifier may be used by advertisement server 104 to identify client 102, as user 402 navigates from webpage 404 through webpage 406. A client identifier may be any form of data used to identify client 102 to advertisement server 104. For example, client 102 may provide a cookie to advertisement server 104 when it requests an advertisement. In cases in which a cookie associated with advertisement server 104 is not already on client 102, advertisement server 104 may provide a cookie to client 102 with a requested advertisement. Whenever user 402 navigates to a webpage that includes an advertisement from advertisement server 104, client 102 may present the cookie back to advertisement server 104. In this way, advertisement server 104 is able to track the browsing history of user 402 (e.g., which webpages were visited by client 102, when the webpages were accessed, etc.). In further implementations, the client identifier may be a unique device ID of client 102, a telephone number of client 102, or the like.

User 402 may self-identify some or all of their demographic information when visiting webpage 406. In one implementation, user 402 may log into a user profile containing information about user 404 via webpage 406. Non-limiting examples of types of websites that may require user 402 to log in include social networking websites, financial websites, news websites, websites that allow a user to save settings or other data, bulletin boards, and other types of websites. In some implementations, advertisement server 104 may receive the demographic information about user 402 from the content source that hosts webpage 406. In other implementations, client 102 may store demographic information about user 402 and provide the demographic information directly to advertisement server 104.

According to one example, user 402 may be a fifty year old male that is college-educated, married with one daughter, has an income of $45,000 per year, and owns his own home. Such information may be provided by user 402 as part of their user profile on the website of webpage 406. Without user 402 self-identifying at least a part of their demographic information, a website may be limited to information about client 102. For example, the content source that provides webpage 404 may have access to information that client 102 is a cellular phone running a specific operating system. However, information about user 402 may be entirely transparent to advertisement server 104.

Advertisement server 104 may associate the known demographic information about user 402 with the known browser history of user 402 (e.g., the webpages visited by user 402 from webpage 404 to webpage 406). Once the demographics of user 402 are known, this also provides insight into the websites previously visited by user 402. For example, while user 402 may not provide demographic information to webpage 404, advertisement server 104 may have information that user 402 is a college-educated homeowner that is fifty years old, is married with a daughter, and has an income of $45,000 per year (e.g., as provided by the content source of webpage 406). Therefore, advertisement server 104 is also able to associate characteristics of webpage 404 with the demographics of user 402. For example, webpage 404 may have certain content that corresponds to word clusters stored on advertisement server 104. In this way, advertisement server 104 is able to construct a training set of data for its demographics model.

According to various implementations, advertisement server 104 may receive demographics data and browser history data for a plurality of users. For each user in the set, the demographics data about the user may be associated with the browser history data for the user. The information about the set of users may be used by advertisement server 104 to train a demographics model that estimates a user's demographics based on the characteristics of a requested webpage. In various implementations, the set of users for the training set may include less than 1,000 users, less than 10,000 users, less than 100,000 users, less than 1,000,000 users, or more than 1,000,000 users. In general, the larger the training set, the greater the ability of advertisement server 104 to correctly predict user demographics. In various implementations, the browser history used in the training set may be limited to a certain timeframe. For example, the browser history for a user may include those webpages visited by a user in the previous half hour, previous day, previous week, previous month, previous year, or the entire browser history for the user.

In one implementation, logistic regression may be used by advertisement server 104 to create a model to estimate user demographics for a webpage. In general, a logistic regression function may be defined as follows:

$$f ( z ) = \frac{1}{1 + {e}^{- z}}$$

where f(z) represents the probability of an outcome, given a set of factors represented by z. The value of z may be determined as follows:

z=β₀+β₁x₁+β₂x₂+ . . . +βₖxₖ

where β₀ is the y-axis intercept, xᵢ is a characteristic affecting the probability outcome, and βᵢ is a regression coefficient (e.g., how much xᵢ affects the outcome). Training of the logistic regression model may be achieved by using the demographics data for a set of users and the characteristics of webpages that they visit. According to some implementations, one or more values of xᵢ may be based on the presence of a word cluster on a webpage as it relates to the demographic. For example, the presence of a word cluster relating to boxing on a webpage may affect the probability that a reader of the webpage is male. In further implementations, other models may be used, such as naïve Bayesian, linear regression, etc., and trained in a similar manner using data about a set of users having known demographics.

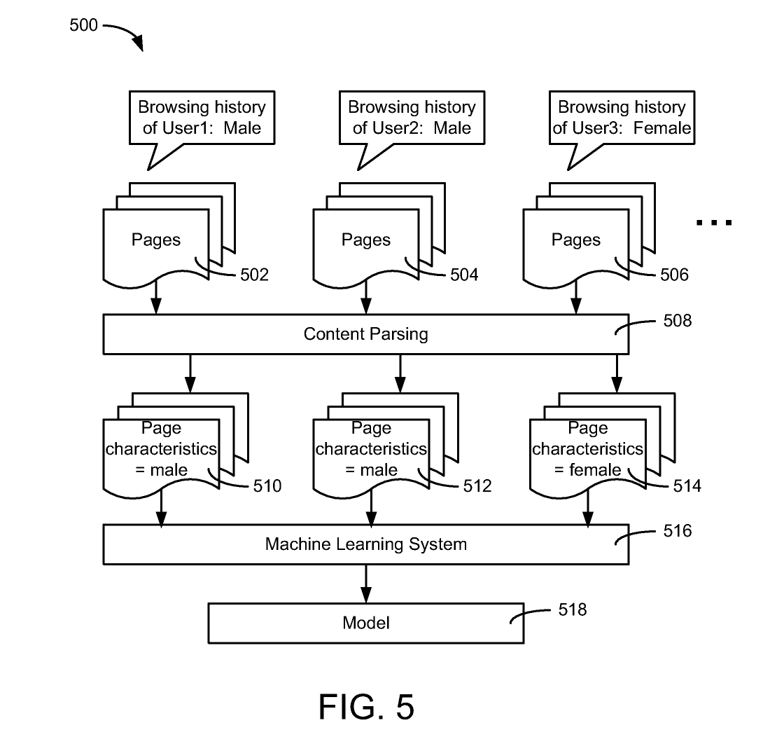

FIG. 5 is an illustration of a model 518 being trained to estimate a user's gender. In system 500, a set of users may have a number of webpages in their browser histories. For example, a first user may have browser history data 502, a second user may have browser history data 504, and a third user may have browser history data 506. If the gender of a user is known, the user's gender may be associated with the webpages in their browser history data. For example, the first and second users may be male, while the third user is female. Webpages in browser history data 502 and browser history data 504 may then be associated with the male demographic, while the webpages in browser history data 506 may be associated with the female demographic, according to some implementations. Model 518 may be trained using data from any number of different users. For example, while browser history data is shown in FIG. 5 for three users, the set of users may be less than a million, less than one hundred thousand, less than ten thousand, less than one thousand, or less than one hundred, according to various implementations.

Webpages in browser history data 502, 504, 506 may be parsed for content by a parser module 508 (i.e., machine instructions executed by a processor), according to various implementations. For example, a first webpage in browser history data 502 may be parsed and the presence of the terms “golf” and “hotel” detected in the text of the webpage. A second webpage in browser history data 502 may also be parsed and the presence of the terms “baseball” and “boxing” detected in the text of the second webpage. Some or all of the webpages in browser history data 502, 504, 506 may be parsed in this manner to identify the characteristics of the webpages. In some implementations, parsed words from a webpage may be grouped as part of a word cluster. The word cluster may then be treated as a characteristic of the webpage. In this way, the meaning behind a particular term may be associated with a webpage, allowing webpages that use similar, but different, terminology to be classified similarly in terms of webpage characteristics.

In some implementations, the demographics and/or other information about a user may be associated with the characteristics of the webpages in that user's browser history data. For example, page characteristics 510, 512, 514 may be associated with the demographics data for the users associated with browser history data 502, 504, 506, respectively (e.g., the male demographic may be associated with page characteristics 510, 512 and the female demographic may be associated with page characteristics 514). In one example, the content words “golf,” “hotel,” baseball,” and “boxing” parsed from the webpages of browser history data 502 may be associated with the male demographic. Similarly, page characteristic 514 may be associated with the female demographic, since the user associated browser history data 506 is female.

Page characteristics 510, 512, 514 and their associated demographics may be used as training data for a machine learning system 516, according to some implementations. In some cases, the percentages of a demographic that visits webpages having a particular characteristic may be used to estimate the demographics of other users. For example, the content term “golf” or a word cluster containing the term “golf” may have the following gender distribution:

TABLE 1

| | Visits to webpases | |
|---|---|---|
| Gender | that mention “golf” | % of Total |
| Male | 450,000 | 45% |
| Female | 550,000 | 55% |
| Totals | 1,000,000 | 100% |

As shown in Table 1, a sample set of users that visited webpages that mention golf may indicate a gender bias in favor of females. Such information may be used by machine learning system 516 to develop model 518. For example, model 518 may treat the probability that a visitor to a webpage devoted to golf as being 0.55, based on the training data in Table 1. Such probabilities may be combined to estimate a demographic of a user, such as the user's gender, when the demographic of the user is unknown.

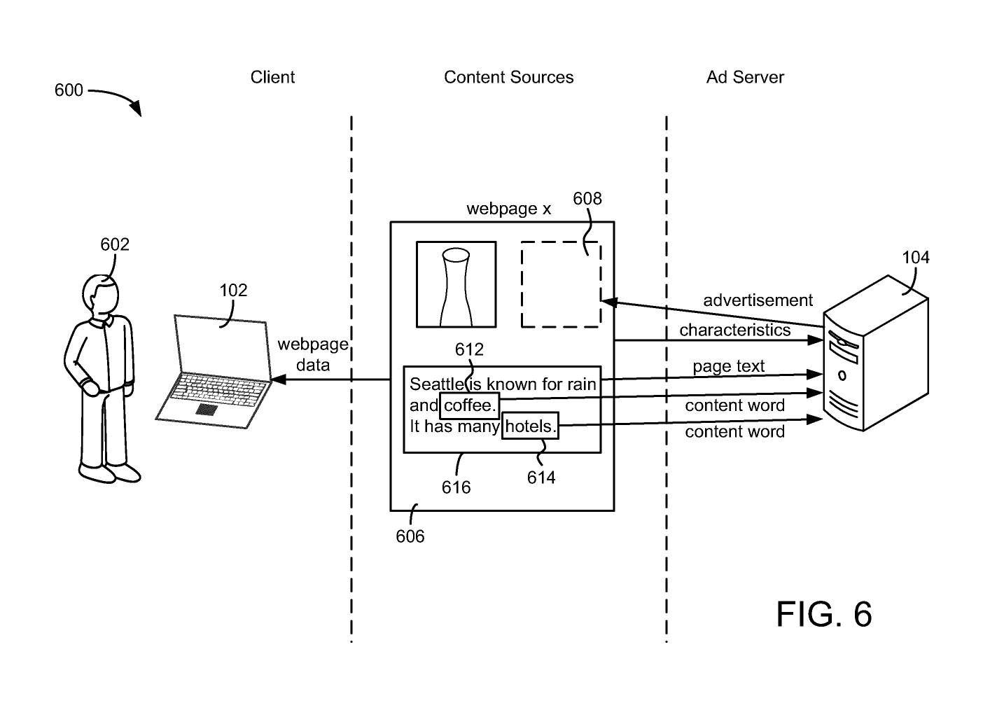

FIG. 6 is an illustration 600 of an online advertisement being provided based on estimated user demographics. As shown, a user 602 may use client 102 to browse webpage 606 provided by a content source. For example, user 602 may use client 102 to request and retrieve webpage 606. Webpage 606 may include an advertisement tag configured to position an advertisement in advertisement slot 608 on webpage 606. Webpage 606 may include an advertisement tag configured to cause client 102 to also retrieve an advertisement from advertisement server 104 to be included in advertisement slot 608. In another implementation, the content server providing webpage 606 may request the advertisement from advertisement server 104 and position the advertisement in advertisement slot 608. In either case, advertisement server 104 may determine which advertisement is to be provided based in part on an estimated demographic of user 602.

According to various implementations, advertisement server 104 may estimate a demographic of user 602 using the content of webpage 606, itself. For example, webpage 606 may be devoted to tourist information for Seattle, Wash. Webpage 606 may include images, text 616, and other content that may be used to estimate the demographics of user 602. For example, advertisement server 104 may parse text 616 to identify one or more content words 612, 614. In some implementations, one or more content words on webpage 606 may be used to estimate user demographics. For example, content word 612, e.g., “coffee,” may be part of a word cluster that also includes the words “java,” “joe,” and “cappuccino.” Similarly, content word 614, e.g., “hotels” may be part of a word cluster that also includes the words “inns,” “hostels,” “lodges,” “motels,” “public houses,” and “spas.” Advertisement server 104 may use a trained model that determines the probability that user 602 is part of a certain demographic, based on the word clusters associated with the content of webpage 606. For example, the word cluster including the word “hotels” may have a trained probability of 0.55 that user 602 is female. Similarly, the word cluster for “coffee” may have a trained probability of 0.85 that user 602 is female. These probabilities may be used with the model to estimate that user 602 is likely female.

In another example, the domain of webpage 606 may be another type of webpage characteristic that may be used by advertisement server 104 to estimate a demographic of user 602. For example, webpage 606 may be hosted on a website devoted to travel. Other webpages on the travel website may have estimated user demographics that favor one gender over another. For example, the most prevalent demographic of a visitor to other webpages on the website may be females between the ages of 35-40. In such a case, this information may be used by advertisement server 104 to estimate the demographics of user 602.

According to some implementations, advertisement server 104 may use an estimated demographic of user 602 to determine which advertisement is presented in advertisement slot 608. In some cases, an advertisement auction may ensue automatically on advertisement server 104 among advertisers. In such an auction, an advertiser may bid more to target certain demographics. For example, an advertiser wishing to advertise to females between the ages of 35-40 may automatically place a higher bid within advertisement server 104, in order to place an advertisement in advertisement slot 608. The advertisement of the winning bidder may be provided to client 102 and/or a content server, to display the advertisement to user 602. In some implementations, the estimation of the demographic of user 602 may be made solely on the characteristics of webpage 606 (e.g., without relying on webpages previously visited by user 602). In other implementations, the characteristics of webpage 606 may be combined with short-term browsing history data for user 506 to estimate their demographics.

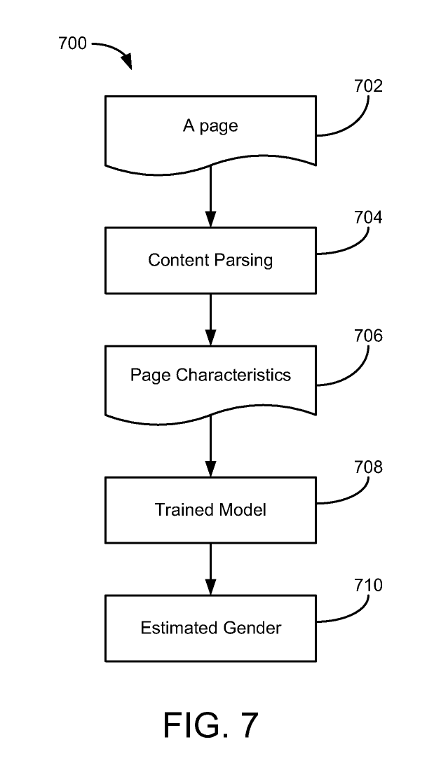

FIG. 7 is an illustration of a user's gender being estimated based on the content of a webpage 706. Once a model 708 has been trained using information about users having known demographics, model 708 can then be used to estimate (e.g., infer) the demographics of a user visiting webpage 706 based on the characteristics of webpage 706. For example, model 708 may be used to determine an estimated gender 710 of a user visiting webpage 702, based on the content of webpage 702. Estimated gender 710 may be used, in some implementations, to select an advertisement to be provided with webpage 702. For example, if estimated gender 710 is female, an advertisement targeted towards women may be provided on webpage 702.

System 700 may include parsing module 704 (i.e., machine instructions) to parse webpage 702. Parsing module 704 may determine one or more page characteristics 706 of webpage 702. For example, webpage 702 may include the term “golf” as part of its text. Parsing module 704 may detect the presence of “golf” in the text of webpage 702 and treat the term as one of the page characteristics 706. In some implementations, parsing module 704 may determine a word cluster that includes a term parsed from webpage 702 and treat the word cluster as one of the page characteristics 706. For example, the term “golf” may be part of a word cluster that also includes “eighteen holes” and “nine holes.” Such a word cluster may then be utilized as one of the page characteristics 706 of webpage 702.

System 700 may also include instructions that apply model 708 to page characteristics 706, to determine estimated gender 710. For example, page characteristics 706 may include word clusters that relate to travel, golf, and hotels. Each cluster may have an associated probability in model 708 that a webpage visitor is of a particular gender. These probabilities may be combined in model 708 to estimate the gender of a visitor to webpage 702. For example, the probability that a visitor to a webpage containing word clusters related to travel, golf, and hotels is female may be 0.75. In such a case, estimated gender 710 may be female, based on the characteristics of webpage 702. In some implementations, estimated gender 710 may then be used to select an advertisement to be provided with webpage 702 (e.g., embedded on webpage 702, as a pop-up advertisement, etc.).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs embodied in a tangible medium, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computerized method for estimating a demographic of a user, comprising:
receiving, at a processing circuit, a request for an advertisement to be placed on a webpage requested by a user, the webpage comprising text;
determining, by a processing circuit, one or more webpage word clusters, each webpage word cluster comprising a word in the text of the webpage;
matching the one or more webpage word clusters to one or more word clusters in a demographics model, wherein each word cluster in the demographics model is associated with a probability of a user belonging to a demographic;
estimating a demographic of the user based in part on the one or more probabilities associated with the word clusters in the demographics model that match the one or more webpage word clusters; and
providing the advertisement based in part on the estimated demographic of the user.

2. The method of claim 1, further comprising:
generating the demographics model based in part on received demographics for a set of users and on word clusters of webpages visited by the set of users.

3. The method of claim 2, wherein the demographics for the set of users are based on user profiles for a website.

4. The method of claim 1, wherein the demographics model comprises a logistic regression model.

5. The method of claim 1, wherein the advertisement is selected based on an advertisement auction, a bid by an advertiser in the auction being based in part on the estimated demographic of the user.

6. The method of claim 1, wherein the demographic of the user is estimated without being based on webpages visited by the user prior to requesting the webpage.

7. The method of claim 1, wherein a word cluster comprises words having similar meanings.

8. The method of claim 1, wherein the one or more webpage word clusters are determined by retrieving the webpage and parsing the text of the webpage.

9. The method of claim 1, wherein the requested webpage was not used to train the demographics model.

10. A system for estimating a demographic of a user comprising a processing circuit operative to:
receive a request for an advertisement to be placed on a webpage requested by a user, the webpage comprising text;
determine one or more webpage word clusters, each webpage word cluster comprising a word in the text of the webpage;
match the one or more webpage word clusters to one or more demographics model word clusters, wherein each demographics model word cluster is associated with a demographics probability;
estimate a demographic of the user based in part on the one or more demographics probabilities associated with the demographics model word clusters that match the one or more webpage word clusters; and
provide the advertisement based in part on the estimated demographic of the user.

11. The system of claim 10, wherein the processing circuit is further operative to:
generate the demographics model based in part on received demographics for a set of users and on word clusters of webpages visited by the set of users.

12. The system of claim 11, wherein the demographics for the set of users are based on user profiles for a website.

13. The system of claim 10, wherein the demographics model comprises a logistic regression model.

14. The system of claim 10, wherein the advertisement is selected based on an advertisement auction, a bid by an advertiser in the auction being based in part on the estimated demographic of the user.

15. The system of claim 10, wherein the demographic of the user is estimated without being based on webpages visited by the user prior to requesting the webpage.

16. The system of claim 10, wherein a word cluster comprises words having similar meanings.

17. The system of claim 10, wherein the one or more webpage word clusters are determined by retrieving the webpage and parsing the text of the webpage.

18. The system of claim 10, wherein the requested webpage was not used to train the demographics model.

19. A computer-readable medium having machine instructions stored therein, the instructions being executable by one or more processors to cause the one or more processors to perform operations comprising:
receiving a request for an advertisement to be placed on a webpage requested by a user, the webpage comprising text;
determining one or more webpage word clusters, a webpage word cluster comprising a word in the text of the webpage;
matching the one or more webpage word clusters to one or more word clusters in a demographics model, wherein a word cluster in the demographics model has an associated probability of the user belonging to a demographic;
estimating a demographic of the user based in part on the one or more probabilities associated with the word clusters in the demographics model that match the one or more webpage word clusters; and
providing the advertisement based in part on the estimated demographic of the user.

20. A computerized method for estimating user demographic data, comprising:
receiving, at a processing circuit, demographic data for a set of users;
retrieving, from a memory, browser history data for the set of users;
associating, by the processing circuit, the demographic data with one or more characteristics of webpages in the browser history data;
receiving a request for an advertisement to be placed on a webpage requested by a user;
identifying characteristics of the webpage that match the characteristics of webpages in the browser history data;
retrieving demographic data associated with the identified characteristics of webpages; and
providing the advertisement based in part on the retrieved demographic data.

21. The method of claim 20, wherein the one or more characteristics comprises a word cluster based in part on the text of the one or more websites in the browser history data.

22. The method of claim 20, wherein the demographic data is associated with the one or more characteristics of webpages in the browser history data using a logistic regression model.

23. The method of claim 20, wherein the advertisement is selected based on an advertisement auction, a bid by an advertiser in the auction being based in part on the estimated demographic.

24. A system for estimating user demographics comprising a processing circuit operative to:
receive demographic data for a set of users;
receive browser history data for the set of users;
associate the demographic data with one or more characteristics of webpages in the browser history data;
receive a request for an advertisement to be placed on a webpage requested by a user;
estimate a demographic of the user by matching one or more characteristics of the webpage with the one or more characteristics with which demographic data is associated; and
provide the advertisement based in part on the estimated demographic.

25. The system of claim 24, wherein the one or more characteristics comprise a word cluster based in part on the text of the one or more websites in the browser history data.

26. The system of claim 24, wherein the processing circuit is operative to conduct an advertisement auction to select the advertisement, a bid by an advertiser in the auction being based in part on the estimated demographic.

27. The system of claim 24, wherein the demographic data for the set of users is based on user profiles for a website.

28. The system of claim 25, wherein the demographic data is associated with the one or more characteristics of webpages in the browser history data using a logistic regression model.
